(19) United States
(12) Patent Application Publication
(10) Pub. No.: US 2024/0160891 A1
(43) Pub. Date: May 16, 2024

(54) MEMORY ALLOCATION METHOD FOR AI PROCESSOR, COMPUTER APPARATUS, AND COMPUTER-READABLE STORAGE MEDIUM

(71) Applicant: ALLWINNER TECHNOLOGY CO., LTD., Zhuhai, Guangdong (CN)

(72) Inventors: Houyi WANG, Zhuhai, Guangdong (CN); Ran DING, Zhuhai, Guangdong (CN); Nan NAN, Zhuhai, Guangdong (CN)

(73) Assignee: ALLWINNER TECHNOLOGY CO., LTD., Zhuhai, Guangdong (CN)

(21) Appl. No.: 18/281,891

(22) PCT Filed: Mar. 26, 2021
(86) PCT No.: PCT/CN2021/083276

§ 371 Date: Sep. 13, 2023

(51) Int. Cl. G06N 3/04

(52) U.S. Cl. CPC G06N 3/04

(57) ABSTRACT

A memory allocation method for an AI processor, a computer apparatus, and a computer-readable storage medium. The method includes: obtaining a plurality of operators of a neural network; analyzing an operator whose input and output occupy memory space that can overlap; determining whether a size of an input of the neural network is fixed; and if yes, determining storage addresses of a memory blocks by using a static memory pool allocation algorithm: calculating a size of each memory block in an inference process of a neural network model, determining a life cycle of each memory block, determining whether the memory block is a memory block that can be overlapped and if yes, correcting the size and the life cycle of the memory block, and allocating a storage address to each memory block.

### TECHNICAL FIELD

The present invention relates to the field of memory management technologies, and specifically, to a memory allocation method for an AI processor, and a computer apparatus and a computer-readable storage medium for implementing the method.

### BACKGROUND

Currently, deep neural network technologies have achieved great success in fields such as computer vision and natural language processing. In recent years, with the rise of an AIoT (Artificial Intelligence & Internet of Things) technology, an artificial intelligence technology and an Internet of Things technology are constantly integrated in actual application, and increasingly more deep learning algorithms need to be deployed on an embedded end device with limited resources. However, because a computing capability and a memory resource of the embedded end device are limited, a high-performance and high-efficiency edge inference method needs to be studied to facilitate deployment of a neural network model.

In recent years, some researchers have focused on model inference performance of a neural network, and designed high-efficiency neural network structures such as SqueezeNet, MobileNets, and EfficientNet. These neural network models can obtain good performance by using a small calculation amount. In addition, some other researchers focus on improving efficiency of the neural network model, compress, prune, and quantize the neural network model, and significantly reduce a calculation amount and memory consumption without significantly reducing performance of the neural network model.

A large quantity of matrix multiplication and addition operations are performed in a forward inference process of a deep neural network, and these operations can be highly parallelized. Therefore, the researchers start to study an artificial intelligence processor that has a parallel computing capability, namely, an AI processor. The AI processor maps a calculation part of the entire neural network to hardware logic, to complete hardware acceleration of the calculation part of the neural network model, thereby alleviating a problem of a limited computing capability of the embedded end device to a specific degree. However, a large quantity of weights and a large amount of activation in the forward inference process of the deep neural network still need to be stored. For example, an ResNet50 model in a Caffe framework requires approximately memory space of 170 MB during inference. However, storage space of the embedded end device is usually limited. Therefore, memory consumption of the neural network during model inference urgently needs to be reduced.

In an existing solution, a dynamic memory allocation method is used in a model inference process of a neural network. In this method, a large amount of memory consumption may be reduced. However, memory space needs to be frequently allocated and released in each inference process. This inevitably affects execution efficiency during model inference, and increases time consumption of model inference. In another solution, based on a characteristic of the AI processor, operators such as convolution, normalization, and pooling in the neural network are directly calculated in an in-place (in-place processing) manner, to reduce memory consumed by some operators in the neural network. In addition, more existing solutions are to consider designing a static memory pool allocation method to reduce memory consumption. Before model inference, memory space is uniformly allocated, a size of a memory block required in an inference process and an address offset thereof are determined, and previously requested memory space is uniformly released before the last model inference is completed.

However, none of the foregoing solutions considers an actual situation of the neural network. Either technical efficiency of the neural network is affected, or a large amount of memory space is still occupied. Therefore, the researchers study memory allocation in a manner of combining a static memory pool allocation method and dynamic memory allocation, for example, an implementation method for a high-efficiency memory pool of an embedded system disclosed in Chinese Patent Application No. CN101968772A. However, in this method, memory is not properly allocated based on a specific situation of each operator of the neural network. Consequently, memory usage is still high.

### Technical Problem

A first objective of the present invention is to provide a memory allocation method for an AI processor, to reduce memory space occupied in an inference process of a neural network.

A second objective of the present invention is to provide a computer apparatus for implementing the foregoing memory allocation method for an AI processor.

A third objective of the present invention is to provide a computer-readable storage medium for implementing the foregoing memory allocation method for an AI processor.

### Technical Solutions

To implement the first objective of the present invention, the memory allocation method for an AI processor provided in the present invention includes: obtaining a plurality of operators of a neural network; calculating and analyzing an operator that is in the plurality of operators and whose input and output occupy memory space that can overlap; and determining whether a size of an input of the neural network is a fixed size; and if yes, determining storage addresses of a plurality of memory blocks by using a static memory pool allocation algorithm; otherwise, requesting memory space for a plurality of memory blocks by using a dynamic memory pool allocation algorithm, where the determining storage addresses of a plurality of memory blocks by using a static memory pool allocation algorithm includes: calculating a size of each memory block in an inference process of a neural network model, determining a life cycle of each memory block, determining whether the memory block is a memory block that can be overlapped, and if the memory block is a memory block that can be overlapped, correcting the size and the life cycle of the memory block, and allocating a storage address to each memory block based on the corrected size and life cycle of the memory block.

In a preferred solution, the calculating and analyzing an operator that is in the plurality of operators and whose input and output occupy memory space that can overlap includes: determining whether input and output activations of an operator participate only in calculation of an operator at a current layer; and if the input and output activations of the operator participate only in calculation of the operator at the current layer, determining that memory space occupied by an input and an output of the operator can overlap; otherwise, determining that memory space occupied by an input and an output of the operator cannot overlap.

Preferably, the analyzed operator is an operator that undergoes linear splitting.

In a further solution, the determining a life cycle of each memory block includes: calculating the life cycle of the memory block based on the first access time and the last access time of an operator stored in the memory block.

In a still further solution, the allocating a storage address to each memory block based on the corrected size and life cycle of the memory block includes: placing each memory block into a static memory pool based on the corrected size and life cycle of the memory block, and calculating an offset address of each memory block by using a heuristic algorithm.

In a still further solution, before the storage address is allocated to each memory block, a size of the static memory pool is determined: a size of a memory block set at any moment is calculated, and a minimum value of a memory block set required at any moment is used as a lower limit value of the size of the static memory pool.

In a still further solution, the requesting memory space for a plurality of memory blocks by using a dynamic memory pool allocation algorithm includes: determining a size of memory space required for calculating a current operator; determining whether an idle memory block that meets a requirement exists in a memory linked list; and if an idle memory block that meets the requirement exists in the memory linked list, using the idle memory block that meets the requirement as memory required for calculating the current operator, and removing the idle memory block from the memory linked list.

In a still further solution, after a life cycle of a memory block ends, the memory block is released and inserted into the memory linked list.

In a still further solution, if no idle memory block that meets the requirement exists in the memory linked list, the memory space required for calculating the current operator is requested.

In a still further solution, the using the idle memory block that meets the requirement as memory required for calculating the current operator includes: using, as a memory block corresponding to the current operator, an idle memory block that is in the memory linked list, that meets a requirement of the memory space required for calculating the current operator, and that has minimum memory space.

In a still further solution, the using the idle memory block that meets the requirement as memory required for calculating the current operator includes: determining that a ratio of between a size of memory space occupied by the current operator and a size of a used memory block is greater than a preset memory usage ratio.

To implement the foregoing second objective, the computer apparatus provided in the present invention includes a processor and a memory. The memory stores a computer program. When the computer program is executed by the processor, steps of the foregoing memory allocation method for an AI processor are implemented.

To implement the foregoing third objective, the computer-readable storage medium provided in the present invention stores a computer program. When the computer program is executed by a processor, steps of the foregoing memory allocation method for an AI processor are implemented.

### Beneficial Effects

In the method in the present invention, it is determined, based on the input of the neural network, whether to allocate memory space by using the static memory pool allocation algorithm or the dynamic memory pool allocation algorithm. When the input has a fixed size, neural network inference efficiency of the AI processor can be improved. When the input of the neural network does not have a fixed size, the dynamic memory pool allocation manner is used. This can reduce occupied memory space to a largest degree, and reduce an amount of memory occupied in the inference process of the neural network.

In addition, a life cycle of each operator is determined based on an input and an output of the operator. If an operator is used only at a specific layer, memory space occupied by the operator may be used repeatedly, that is, a memory block may separately store a plurality of operators in different time periods in the entire inference process, thereby reducing the amount of memory occupied in the inference process of the neural network.

Moreover, the heuristic algorithm is used to calculate the offset address of each memory block, to determine an absolute address of each memory block. This helps minimize memory space occupied in the inference process of the neural network model.

Furthermore, in a process of allocating memory space by using the dynamic memory pool, a memory block that meets a storage requirement and that has minimum memory space is selected as the memory space required for calculating the current operator, so that memory space occupied in the inference process of the neural network model can be reduced.

In addition, the ratio between the size of the memory space occupied in a process of calculating the current operator and the size of the used memory block is limited, thereby preventing memory space from being wasted because the memory space occupied by the current operator is excessively large, and further reducing the memory space occupied in the inference process of the neural network model.

### BRIEF DESCRIPTION OF DRAWINGS

FIG. 1 is a flowchart of an embodiment of a memory allocation method for an AI processor according to the present invention;

FIG. 2 is a flowchart of determining storage addresses of a plurality of memory blocks by using a static memory pool allocation algorithm in an embodiment of a memory allocation method for an AI processor according to the present invention; and

FIG. 3 is a flowchart of requesting memory space for a plurality of memory blocks by using a dynamic memory pool allocation algorithm in an embodiment of a memory allocation method for an AI processor according to the present invention.

The following further describes the present invention with reference to the accompanying drawings and embodiments.

### EMBODIMENTS OF THE PRESENT INVENTION

A memory allocation method for an AI processor in the present invention is applied to an embedded end device, and the embedded end device includes a processor, configured to execute an artificial intelligence algorithm. Therefore, the processor is referred to as an AI processor. As a computer apparatus, the AI processor is internally disposed with a processor and a memory. The memory stores a computer program. When the computer program is executed by the processor, steps of the foregoing memory allocation method for an AI processor may be implemented.

### Embodiment of a Memory Allocation Method for an AI Processor

This embodiment is applied to the AI processor, and is mainly used to resolve a problem that the AI processor occupies excessively large memory in a calculation process of a neural network. For an existing AI processor, a static memory pool allocation method is mainly used to manage memory allocation in an inference process of a neural network model. A memory reuse efficiency problem exists in an existing method, and memory resource required for model calculation cannot be reduced to a largest degree. In addition, because memory needs to be pre-allocated in advance in the existing static memory pool allocation method, there is a disadvantage that the method is not flexible enough. As a result, the method is mainly applicable to a neural network model that has a fixed input size, and is not applicable to a neural network model that requires a variable input size, for example, a recurrent neural network. This limits an application scenario of the neural network.

Therefore, a main idea of the present invention is to design a high-efficiency memory allocation method that combines a static memory pool and a dynamic memory pool. Two different memory pool allocation manners are more flexible, so that model memory can be efficiently managed, and different model and application scenario requirements can be met. In the static memory pool allocation method, memory is efficiently reused between computing nodes by calculating and analyzing a neural network model, and the method is applicable to a neural network model that has a fixed input size. In the dynamic memory pool allocation method, all memory blocks are organized in a form of a linked list, to improve dynamic memory management efficiency and reduce memory fragments, and the method is applicable to a neural network model that requires a variable input size. In addition, another invention concept of the present invention is to fully consider a hardware characteristic of the AI processor, so that memory blocks used by inputs and outputs of some operators are allowed to overlap, that is, some memory blocks separately store different operators at different moments, thereby further reducing memory consumption during inference of the neural network model.

When a memory block is allocated by using the static memory pool, a size and a life cycle that are of memory space required by each operator in the neural network model are first analyzed. Then, a memory allocation problem is converted into a non-deterministic polynomial problem. Finally, a heuristic algorithm is used to resolve the problem to determine an address offset of each memory block, so as to minimize a size of a memory pool during model inference.

In the dynamic memory pool allocation algorithm, all idle memory blocks is organized in a form of a linked list. When memory space needs to be allocated, each idle memory block in the linked list is traversed until a memory block whose size meets a requirement is found, and the memory block is removed from an idle linked list. If a current memory block is released, the memory block is re-inserted into the idle linked list.

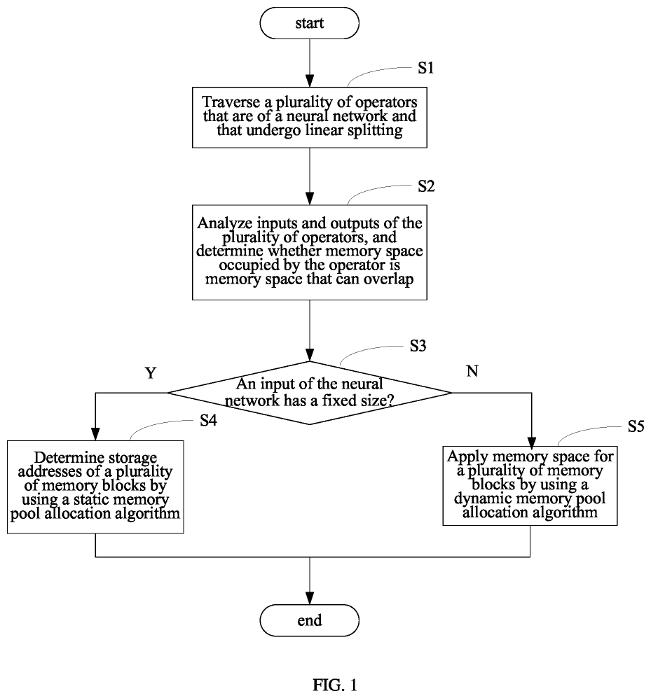

The following describes a specific memory allocation process in this embodiment with reference to FIG. 1. First, step S1 is performed to traverse a plurality of operators of a neural network. Preferably, the plurality of operators of the neural network previously undergo linear splitting, that is, the traversed operators are operators that undergo linear splitting. After step S1 is performed, an operator on which the AI processor can perform in-place calculation may be preliminarily determined.

Next, step S2 is performed to analyze an operator that is in the plurality of operators and that occupies memory space that can overlap. Specifically, based on a hardware characteristic of the AI processor, an operator that is in the neural network and whose input and output occupy memory space that can overlap is determined. Due to a hardware calculation logic characteristic of the AI processor, the AI processor can perform an operation on operators such as convolution, activation, and normalization in an in-place manner. Therefore, in this embodiment, after all operators of the neural network that undergo linear splitting are traversed, and the operator on which the AI processor can perform in-place calculation is preliminarily determined, whether input and output activations of the operator participate in calculation of subsequent another branch is further analyzed. If input and output activations of an operator participate only in calculation of an operator at a current layer, it is determined that memory space occupied by an input and an output that correspond to the operator can overlap, thereby improving memory utilization, and reducing overall memory consumption of the neural network model.

In contrast, in a conventional memory allocation method, a ping-pong cache technology is used to store input and output activations of all operators in separate memory areas, to ensure that memory space of an input and an output does not overlap. However, in this conventional method, a size of the neural network model is limited, and memory utilization of the AI processor is low. This increases power consumption and production costs of an embedded product.

Then, step S3 is performed to determine whether an input of the neural network has a fixed size. If the input of the neural network has a fixed size, step S4 is performed to determine, by using a static memory pool allocation algorithm, an offset address of each memory block before model inference of the neural network. If a determining result of step S3 is no, step S5 is performed to request, by using a dynamic memory pool allocation algorithm, space for each memory blocks during inference of the neural network model.

Specifically, it may be determined, based on a neural network model type and an actual service scenario requirement, whether the model input of the neural network has a fixed and unchanged size. Currently, a convolutional neural network (CNN) model is widely used in the field of computer vision. Most CNN models use a fixed-size image as a model input. Therefore, the static memory pool allocation algorithm can be used to reduce, to a largest degree, memory consumption required for inference of the neural network. In the field of natural language processing, a recurrent neural network (RNN) model is mainly used. For the RNN model, an input needs to have a variable size, and a size of memory that needs to be allocated each time the network performs forward inference is different. Therefore, the static memory pool allocation method is not applicable. In this case, the dynamic memory pool allocation method needs to be used.

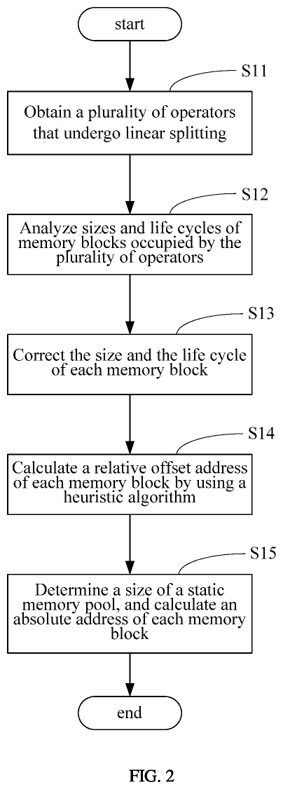

If it is determined that the model input size of the neural network is a fixed size, a process of determining the offset address of each memory block by using the static memory pool allocation algorithm is shown in FIG. 2. First, step S11 is performed to obtain a plurality of operators that undergo linear splitting. Next, step S12 is performed to analyze sizes and life cycles of memory blocks occupied by the plurality of operators. For a given input size, statistics about a size of each memory block required in the inference process of the neural network model are collected, the first accessed time and the last accessed time of the memory block are determined, and a life cycle of the memory block is determined based on the first accessed time and the last accessed time of the memory block. Specifically, after the size and the life cycle of each memory block are given, a memory block set B(t) at any moment t may be obtained. Therefore, a size of memory required at a moment t may be Sₜ through calculation, for example, calculation is performed by using Formula 1:

Sₜ=Σ_{b∈B(t)}s_{b} (Formula 1)

s_{b} represents a size of a memory block b. For an ideal memory management algorithm, only required memory space can be allocated at any given moment t and a size thereof is M, for example, minimum memory space required at each moment t is calculated by using Formula 2:

$$M = {max}_{t} {S}_{t} \qquad ( Formula 2 )$$

The value M calculated by using Formula 2 is used as a lower limit value of a size of a memory pool. In this way, a requirement of memory required for forward inference of the neural network model can be met.

Then, step S13 is performed to correct the size and the life cycle of each memory block. Specifically, based on whether the memory space occupied by each operator can be overlapped in step S2, the size and the life cycle of each memory block are corrected. If a memory block can be overlapped, a size and a life cycle of a related memory block need to be corrected based on a memory block that overlaps the memory block.

Next, address allocation needs to be performed on each memory block, that is, a relative offset address of each memory block in the memory pool is determined. When the size and the life cycle of each memory block and the lower limit value of the size of the memory pool are known, a problem of properly placing the memory block into the static memory pool may be converted into a special two-dimensional strip packing problem, that is, a series of given rectangles need to be placed into a box with a fixed width and an unlimited height, so that a height of the box is minimized. In the strip packing problem, the rectangular set is analogous to the memory block set required for inference of the neural network model, the height of the box is analogous to the size of the static memory pool, and the width of the box is analogous to the time required for model inference. Because each memory block has a fixed life cycle, correspondingly, a rectangle needs to be placed at a fixed horizontal position of the box.

In this embodiment, a simple heuristic algorithm is used to resolve the packing problem, to obtain an optimal solution. For example, the relative offset address of each memory block is determined based on a position of each memory block in a vertical direction of the box. The heuristic algorithm used in this embodiment may also be implemented by using a classical heuristic algorithm such as a best-fit decreasing height (BFDH) algorithm and a floor-ceil (FC) algorithm, to obtain the relative offset address of each memory block.

Finally, step S15 is performed to add the sizes and the relative offset values of the memory blocks based on the relative offset addresses of the memory blocks, sort the results in descending order, use a maximum value in the sorted results as the size of the static memory pool, and request from the system for corresponding memory space. After an address of the memory space is determined, an absolute address of each memory block in the memory pool can be determined.

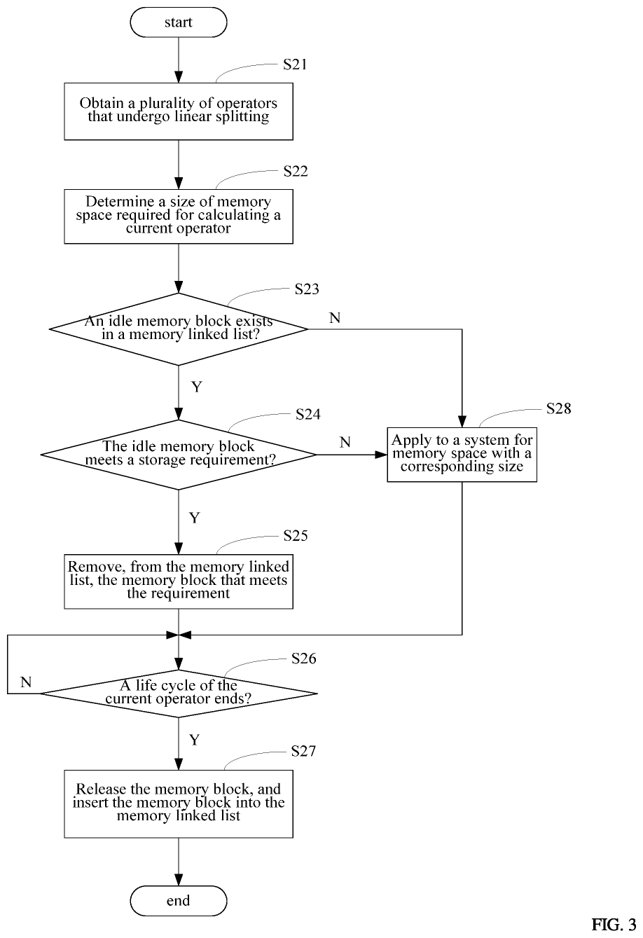

If it is determined that the model input size of the neural network is not a fixed size, a process of allocating memory space to each memory block by using the dynamic memory pool allocation algorithm is shown in FIG. 3.

First, step S21 is performed to obtain a plurality of operators that undergo linear splitting. Next, step S22 is performed to determine a size of memory space required in a calculation process of a current operator, that is, in the forward inference process of the neural network model, a size of output memory space required by the current operator is determined. Specifically, in the model inference process of the neural network, a shape and a size of an input activation of the current operator are obtained. Then, a shape and a size of an output activation are determined based on a related configuration parameter of the current operator. Finally, a size of output memory required by the current operator is obtained based on the shape and the size of the output activation. A convolution operator is used as an example. It is assumed that the shape and the size of the input activation are Wᵢ×Hᵢ×Cᵢ, a convolution kernel size is k_{w}×kₕ, a quantity of convolution kernels is Cₒ, a stride is s, and a padding parameter is p. In this case, the shape and the size of the output activation are Wₒ×Hₒ×Cₒ. Therefore, the size of the output memory required by the current operator is Wₒ×Hₒ×Cₒ, where Wₒ and Hₒ are separately calculated by using Formula 3 and Formula 4:

Wₒ=(Wᵢ−k_{w}+2×p)/s+1 (Formula 3)

Hₒ=(Hᵢ−kₕ+2×p)/s+1 (Formula 4)

Then, step S23 is performed to determine whether an idle memory block exists in a memory linked list. If no idle memory block exists in the memory linked list, step S28 is performed to directly request from the system for memory space with a corresponding size.

If a determining result of step S23 is yes, it indicates that an idle memory block exists in the memory linked list, step S24 is performed to determine whether a size of the idle memory block in the memory linked list meets a requirement. If the size of the idle memory block in the memory linked list does not meet the requirement, step S28 is performed to directly request from the system for memory space with a corresponding size. If the size of the idle memory block in the memory linked list meets the requirement, step S25 is performed to remove the idle memory block that meets the requirement from the memory linked list, and use the memory block as a memory block required for calculating the current operator.

To dynamically allocate each memory block more efficiently, in this embodiment, an effective memory block matching method is used to determine whether the size of the idle memory block in the memory linked list meets the requirement, so that a most matching memory block can be selected from idle memory blocks in the memory linked list to store an output activation. Specifically, first, the idle memory blocks in the memory linked list are sorted in ascending order based on a size of memory. Next, the idle memory blocks in the memory linked list are sequentially traversed. Only when a ratio between a size of memory of the output activation and a size of an idle memory block is greater than a preset memory usage ratio, the idle memory block is selected to store the output activation.

In this embodiment, the memory usage ratio is related to a specific neural network model. A process of selecting a proper memory usage ratio is as follows: First, it is set that a distribution interval of memory usage ratio α is [0,1). Next, statistics about overall memory pool occupancy space sizes M_{α} of a current neural network model in case of all memory usage ratios α are separately collected by using a preset stride (the preset stride may be 0.01). Finally, α parameter α* corresponding to M_{α} with a minimum value is selected as the preset memory usage ratio of the model, and the preset memory usage ratio α* may be implemented by using Formula 5:

$${α}^{*} = {argmin}_{α} {M}_{α} , α ∈ [ 0 , 1 ) \qquad ( Formula 5 )$$

It can be learned that it memory space required tor calculating the current operator is small, a memory block with large memory space is not allocated. In this way, memory waste can be avoided.

Finally, step S26 is performed to determine whether a life cycle of the current operator ends. If the life cycle of the current operator has ended, that is, if a memory block corresponding to the current operator is not required for calculation of a subsequent branch, step S27 is performed to recycle the memory block resource, and re-insert the memory block corresponding to the current operator into the memory linked list, so that the memory block is used by another operator, thereby implementing reuse of the memory block, improving use efficiency of the memory block, and reducing overall memory space occupied by the neural network model. When inference calculation of the entire neural network model is completed and the application program is exited, all memory blocks dynamically requested from the system in the memory pool are released and returned sequentially.

In this embodiment, the life cycle of each memory block during inference of the convolutional neural network model is analyzed, and the static memory pool is used to manage memory of the neural network model. In addition, in this embodiment, a scenario and a requirement of a deep neural network are further fully considered, and the memory allocation method that combines the static memory pool and the dynamic memory pool is used to manage memory during model inference. Therefore, the method in the present invention can be applied to the convolutional neural network with a fixed input size, and can be applied to the recurrent neural network with a variable input size, so that requirements of more different algorithm models and application scenarios are met. In addition, in the present invention, based on the hardware logic characteristic of the AI processor, input memory and output memory of some operators are further allowed to overlap, thereby further reducing specific memory consumption.

Because a large amount of memory with different sizes needs to be requested in the inference calculation process of the neural network model to store an activation value, a memory fragmentation problem is extremely likely to be caused in a conventional memory allocation method. An ResNet50 model is used as an example. Normally, memory needs to be dynamically requested more than one hundred times during forward inference of the model, and space of approximately 25 MB is used to store an activation value of intermediate calculation of the network. In the dynamic memory pool allocation method in the present invention, the life cycle of each memory block is analyzed, and the memory block matching method is used. When inference calculation is performed on the ResNet50, memory needs to be dynamically requested only seven times, and memory space of approximately 3 MB is used. It can be learned that, in the method in the present invention, a quantity of requested memory blocks and a memory pool occupancy space size can be reduced, the memory fragmentation problem during inference calculation of the neural network model is alleviated, and memory utilization is improved.

### Embodiment of a Computer Apparatus

The computer apparatus in this embodiment may be an embedded device, for example, an AI processor. The computer apparatus includes a processor, a memory, and a computer program that is stored in a memory and that can run on the processor. When the processor executes the computer program, steps of the foregoing memory allocation method for an AI processor are implemented.

For example, the computer program may be divided into one or more modules, and the one or more modules are stored in the memory and executed by the processor, to complete modules of the present invention. The one or more modules may be a series of computer program instruction segments that can implement a specific function, and the instruction segment is used to describe an execution process of the computer program in a terminal device.

The processor described in the present invention may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, the processor may be any conventional processor or the like. The processor is a control center of the terminal device, and is connected to various parts of the entire terminal device by using various interfaces and lines.

The memory may be configured to store a computer program and/or a module. The processor implements various functions of the terminal device by running or executing the computer program and/or the module stored in the memory and invoking data stored in the memory. The memory may mainly include a program storage area and a data storage area. The program storage area may store an operating system, an application program required by at least one function (such as a voice playing function and an image playing function), and the like. The data storage area may store data (such as audio data and an address book) created based on use of the mobile phone, and the like. In addition, the memory may include a high-speed random-access memory, and may further include a non-volatile memory such as a hard disk, memory, a plug-connected hard disk, a smart media card (SMC), a secure digital (SD) card, a flash card, at least one disk storage device, a flash memory device, or another volatile solid-state storage device.

### Embodiment of a Computer-Readable Storage Medium

When the computer program stored in the foregoing computer apparatus is implemented in a form of a software functional unit and sold or used as an independent product, the computer program may be stored in a computer-readable storage medium. Based on such an understanding, all or some processes of the methods in the foregoing embodiments of the present invention may also be implemented by a computer program instructing related hardware. The computer program may be stored in a computer-readable storage medium. When the computer program is executed by a processor, steps of the foregoing memory allocation method for an AI processor may be implemented.

The computer program includes computer program code. The computer program code may be in a source code form, an object code form, an executable file form, some intermediate forms, or the like. The computer-readable medium may include any entity or apparatus that can carry computer program code, a recording medium, a USB flash drive, a removable hard disk, a magnetic disk, an optical disc, a computer memory, a read-only memory (ROM), a random-access memory (RAM), an electrical carrier signal, a telecommunication signal, and a software distribution medium, It should be noted that content included in the computer-readable medium may be appropriately added or reduced based on a requirement of legislation and patent practice in a jurisdiction. For example, in some jurisdictions, based on legislation and patent practice, the computer-readable medium does not include the electrical carrier signal and the telecommunications signal.

Finally, it should be emphasized that the present invention is not limited to the foregoing implementations, for example, a change of the used heuristic algorithm, or a change of the specific process of dynamically allocating a memory block. These changes should also be included in the protection scope of the claims of the present invention.

### INDUSTRIAL APPLICABILITY

The present invention may be applied to an embedded end device to perform memory allocation and management in an inference process of a neural network. Specifically, the present invention may be applied to a plurality of deep neural network models in different application scenarios, such as a face detection network and a face recognition network with a fixed input size, or a face detection network with a variable input size. The present invention has a good effect in inference processes of these models.

For example, in a face detection network model, an ResNet18 is used as a basic model, and an input image size is 320×320. When inference is performed by using the conventional memory allocation method, the model needs to consume memory space of 11.8 MB. If the static memory pool allocation algorithm in the present invention is used, memory space of only 1.2 MB needs to be consumed, thereby reducing memory consumption by 89.8%.

In a face recognition network model, an ResNet101 is used as a basic model, and an input image size is 112×112. When inference is performed by using the conventional memory allocation method, the model needs to consume memory space of 21.5 MB. If the static memory pool allocation algorithm in the present invention is used, memory space of only 1.5 MB needs to be consumed, thereby reducing memory consumption by 93%.

In addition, the present invention further supports a scenario in which an input size is not a fixed size. For example, for a face detection network that supports any input image size, the model has two input image sizes: 480×480 and 320×320. When inference is performed by using the conventional memory allocation method, memory space of 18.7 MB needs to be consumed in total. If the dynamic memory pool allocation algorithm in the present invention is used, memory space of only 2.9 MB needs to be consumed, thereby reducing memory consumption by 84.5%.

It can be learned from the foregoing data that, in the method in the present invention, memory consumption during inference of the neural network model can be reduced, and requirements of different algorithm models and application scenarios can be met.

1. A memory allocation method for an AI processor, comprising:
obtaining a plurality of operators of a neural network;
wherein,
calculating and analyzing an operator that is in the plurality of operators and whose input and output occupy memory space that can overlap; and
determining whether a size of an input of the neural network is a fixed size; and if yes, determining storage addresses of a plurality of memory blocks by using a static memory pool allocation algorithm; otherwise, requesting memory space for a plurality of memory blocks by using a dynamic memory pool allocation algorithm, wherein
the determining storage addresses of a plurality of memory blocks by using a static memory pool allocation algorithm comprises: calculating a size of each memory block in an inference process of a neural network model, determining a life cycle of each memory block, determining whether the memory block is a memory block that can be overlapped, and if the memory block is a memory block that can be overlapped, correcting the size and the life cycle of the memory block, and allocating a storage address to each memory block based on the corrected size and life cycle of the memory block.

2. The memory allocation method for an AI processor according to claim 1, wherein
the calculating and analyzing an operator that is in the plurality of operators and whose input and output occupy memory space that can overlap comprises:
determining whether input and output activations of an operator participate only in calculation of an operator at a current layer; and if the input and output activations of the operator participate only in calculation of the operator at the current layer, determining that memory space occupied by an input and an output of the operator can overlap; otherwise, determining that memory space occupied by an input and an output of the operator cannot overlap.

3. The memory allocation method for an AI processor according to claim 2, wherein
the analyzed operator is an operator that undergoes linear splitting.

4. The memory allocation method for an AI processor according to claim 1, wherein
the determining a life cycle of each memory block comprises: calculating the life cycle of the memory block based on the first access time and the last access time of an operator stored in the memory block.

5. The memory allocation method for an AI processor according to claim 1, wherein
the allocating a storage address to each memory block based on the corrected size and life cycle of the memory block comprises: placing each memory block into a static memory pool based on the corrected size and life cycle of the memory block, and calculating an offset address of each memory block by using a heuristic algorithm.

6. The memory allocation method for an AI processor according to claim 5, wherein
before the storage address is allocated to each memory block, a size of the static memory pool is determined: a size of a memory block set at any moment is calculated, and a minimum value of a memory block set required at any moment is used as a lower limit value of the size of the static memory pool.

7. The memory allocation method for an AI processor according to claim 1, wherein
the requesting memory space for a plurality of memory blocks by using a dynamic memory pool allocation algorithm comprises:
determining a size of memory space required for calculating a current operator; determining whether an idle memory block that meets a requirement exists in a memory linked list; and if an idle memory block that meets the requirement exists in the memory linked list, using the idle memory block that meets the requirement as memory required for calculating the current operator, and removing the idle memory block from the memory linked list.

8. The memory allocation method for an AI processor according to claim 7, wherein
after a life cycle of a memory block ends, the memory block is released and inserted into the memory linked list.

9. The memory allocation method for an AI processor according to claim 7, wherein
if no idle memory block that meets the requirement exists in the memory linked list, the memory space required for calculating the current operator is requested.

10. The memory allocation method for an AI processor according to claim 7, wherein
the using the idle memory block that meets the requirement as memory required for calculating the current operator comprises: using, as a memory block corresponding to the current operator, an idle memory block that is in the memory linked list, that meets a requirement of the memory space required for calculating the current operator, and that has minimum memory space.

11. The memory allocation method for an AI processor according to claim 7, wherein
the using the idle memory block that meets the requirement as memory required for calculating the current operator comprises: determining that a ratio between a size of memory space occupied by the current operator and a size of a used memory block is greater than a preset memory usage ratio.

12. A computer apparatus, comprising a processor and a memory, wherein the memory stores a computer program, and the computer program is executed by the processor, steps of the memory allocation method for an AI processor according to claim 1 are implemented.

13. A computer-readable storage medium that stores a computer program, wherein when the computer program is executed by a processor, steps of the memory allocation method for an AI processor according to claim 1 implemented.
